(19) United States
(12) Patent Application Publication
(10) Pub. No.: US 2023/0135522 A1
(43) Pub. Date: May 4, 2023

(54) LIQUID DISCHARGE HEAD, DISCHARGE UNIT, AND LIQUID DISCHARGING APPARATUS

(71) Applicants: Yu WATANABE, Kanagawa (JP); Takuma HIRABAYASHI, Tokyo (JP)

(72) Inventors: Yu WATANABE, Kanagawa (JP); Takuma HIRABAYASHI, Tokyo (JP)

(21) Appl. No.: 17/960,833

(22) Filed: Oct. 6, 2022

(30) Foreign Application Priority Data
Oct. 28, 2021 (JP) 2021-176600

(51) Int. Cl. B41J 2/14

(52) U.S. Cl. CPC B41J 2/1433; B41J 2/14201; B41J 2002/14403

(57) ABSTRACT

A liquid discharge head includes: a nozzle plate having multiple nozzles from each of which a liquid is to be discharged; a first substrate including multiple pressure chambers respectively communicating with the multiple nozzles; and a second substrate including: a common channel communicating with the multiple pressure chambers, the common channel extending in a longitudinal direction of the second substrate; and a reinforcement in the common channel, the reinforcement intersecting the longitudinal direction.

### CROSS-REFERENCE TO RELATED APPLICATIONS

This patent application is based on and claims priority pursuant to 35 U.S.C. §119(a) to Japanese Patent Application No. 2021-176600, filed on Oct. 28, 2021, in the Japan Patent Office, the entire disclosure of which is hereby incorporated by reference herein.

### BACKGROUND

### Technical Field

Embodiments of this disclosure relate to a liquid discharge head, a discharge unit, and a liquid discharging apparatus.

### Related Art

A liquid discharge head discharges a liquid. The liquid discharge head includes a nozzle plate having multiple nozzles from which a liquid is to be discharged, an individual channel member including multiple pressure chambers respectively communicating with the nozzles, and a common channel member including a common channel communicating with the pressure chambers.

The liquid discharge head includes a channel forming substrate and a bonding substrate made of a material different from the material of the channel forming substrate. The bonding substrate is bonded to the channel forming substrate. The channel forming substrate has a low rigidity part lower in rigidity than other parts in an outer peripheral portion on one side of the channel forming substrate.

A method for manufacturing the liquid discharge head includes a process for integrally forming multiple channel forming substrates on a silicon wafer and providing multiple through holes aligned at specified intervals between the channel forming substrates on the silicon wafer to form a break pattern, a process for bonding a bonding substrate to a channel forming substrate, and a process for dividing the silicon wafer along the break pattern into the channel forming substrates. During the formation of the break pattern, through holes are successively formed in portions of the silicon wafer that correspond to the low rigidity parts.

### SUMMARY

A liquid discharge head includes: a nozzle plate having multiple nozzles from each of which a liquid is to be discharged; a first substrate including multiple pressure chambers respectively communicating with the multiple nozzles; and a second substrate including: a common channel communicating with the multiple pressure chambers, the common channel extending in a longitudinal direction of the second substrate; and a reinforcement in the common channel, the reinforcement intersecting the longitudinal direction.

A liquid discharge head includes: a nozzle plate having multiple nozzles from each of which a liquid is to be discharged; a first substrate including multiple pressure chambers respectively communicating with the multiple nozzles; and a second substrate including a hole region having multiple holes, the multiple holes defining a common channel communicating with each of the multiple pressure chambers.

A discharge unit includes the liquid discharge head, and the liquid discharge head includes multiple liquid discharge heads.

A liquid discharging apparatus includes the liquid discharge head.

A liquid discharging apparatus includes the discharge unit.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a perspective view illustrating an appearance of a liquid discharge head according to a first embodiment of this disclosure;

FIG. 2 is a cross-sectional view of the liquid discharge head in FIG. 1;

FIGS. 3A and 3B are plan views of a second substrate;

FIGS. 4A and 4B are diagrams for explaining a state where the second substrate and a damper member are bonded to each other;

FIG. 5 is a plan view of a first substrate;

FIG. 6 is a perspective view for explaining a state where the first substrate and the second substrate are bonded to each other;

FIG. 7 is a perspective view for explaining a state where the second substrate is bonded to a dicing tape;

FIG. 8 is a plan view for explaining expansion;

FIGS. 9A and 9B are plan views of the second substrate in the first embodiment, for explaining effects of a reinforcement provided;

FIGS. 10a and 10B are plan views of a second substrate in Comparative Example 1;

FIG. 11 is a perspective view illustrating a second substrate in a liquid discharge head according to a second embodiment of this disclosure, along with a dicing tape;

FIG. 12 is a plan view of a second substrate in a liquid discharge head according to a third embodiment of this disclosure;

FIG. 13 is a perspective view illustrating an appearance of a liquid discharge head according to a fourth embodiment of this disclosure;

FIG. 14 is a perspective view illustrating an appearance of the liquid discharge head in FIG. 13 as viewed from a side opposite with a nozzle face side;

FIG. 15 is an exploded perspective view of the liquid discharge head in FIG. 13;

FIG. 16 is an exploded perspective view of channel constituent members in the liquid discharge head in FIG. 13;

FIG. 17 is an enlarged perspective view of a principal part of the channel constituent members in FIG. 16;

FIG. 18 is a perspective view of a cross section of a channel part in the liquid discharge head in FIG. 13;

FIG. 19 is a schematic side view of an example of a printing apparatus as a liquid discharging apparatus according to this disclosure; and

FIG. 20 is a plan view of a discharge unit of the printing apparatus in FIG. 19. The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

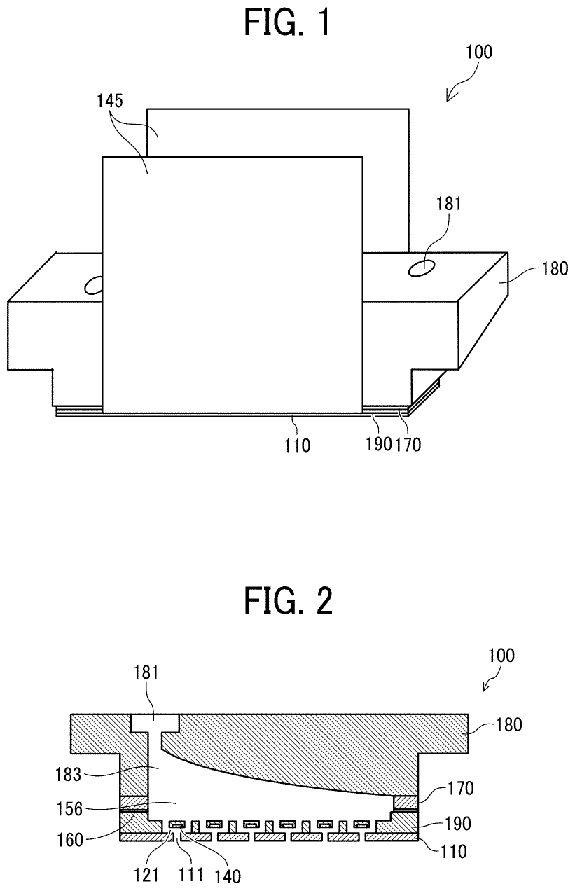

In the following, embodiments of this disclosure are described with reference to the accompanying drawings. A first embodiment of this disclosure is described with reference to FIGS. 1 through 7. FIG. 1 is a perspective view illustrating an appearance of a liquid discharge head according to the first embodiment, and FIG. 2 is a cross-sectional view of the liquid discharge head in FIG. 1.

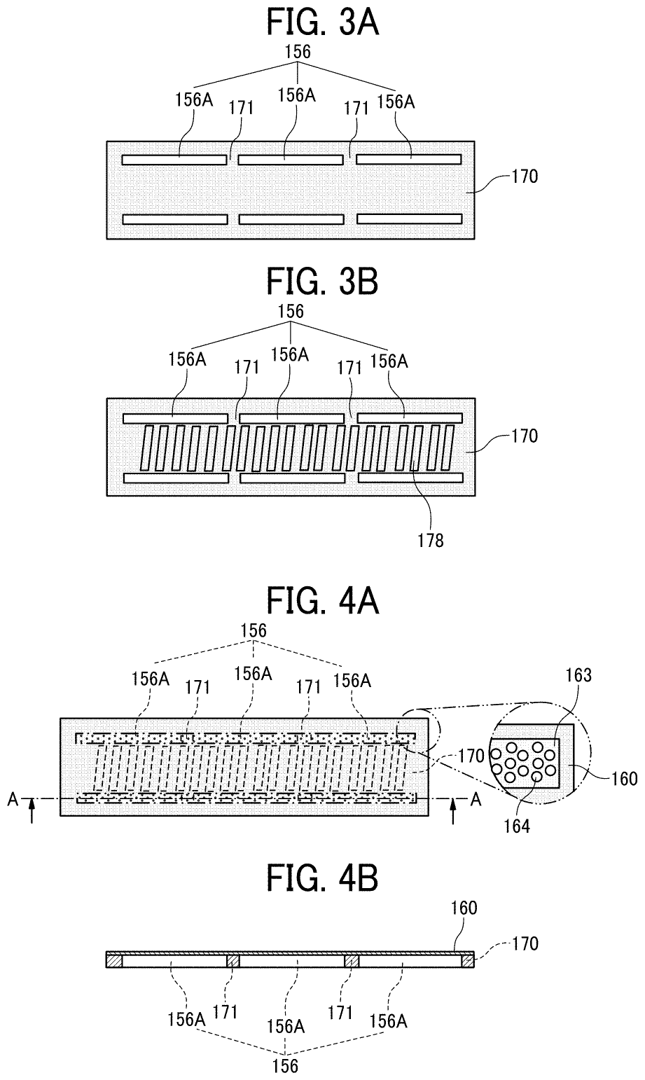

FIGS. 3A and 3B are plan views of a second substrate.

FIGS. 4A and 4B are diagrams for explaining a state in which the second substrate and a damper member are bonded to each other.

FIG. 4A is a plan view, and FIG. 4B is a cross-sectional view along a line A-A in FIG. 4A.

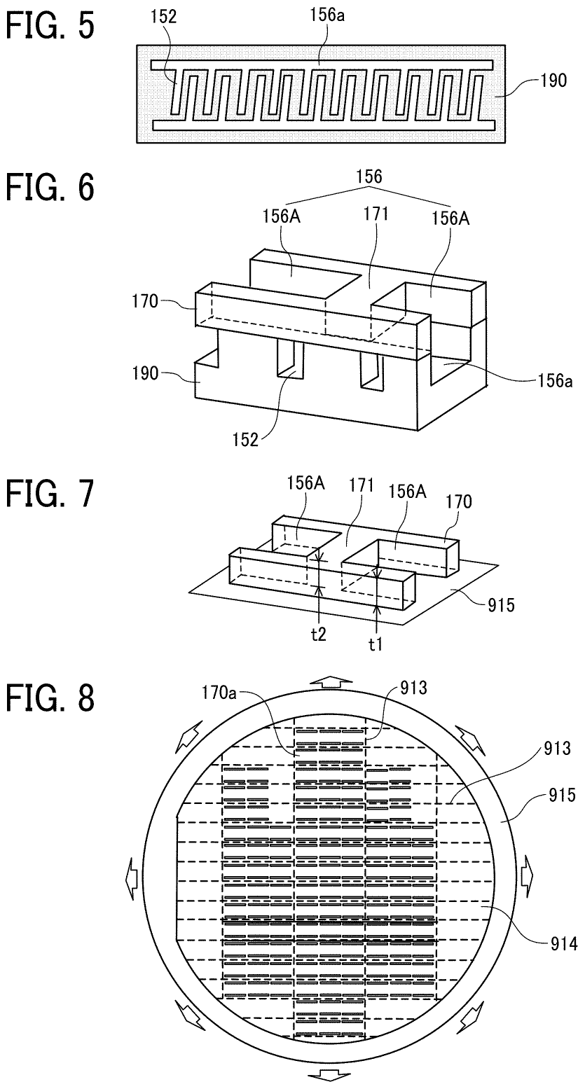

FIG. 5 is a plan view of a first substrate.

FIG. 6 is a perspective view for explaining a state where the first substrate and the second substrate are bonded to each other.

FIG. 7 is a perspective view for explaining a state where the second substrate is bonded to a dicing tape. The damper member is omitted from FIG. 6.

A liquid discharge head 100 includes a nozzle plate 110, a first substrate 190, a second substrate 170, a damper member 160, a frame member 180, and a wiring member 145 (flexible circuit substrate).

The nozzle plate 110 has multiple nozzles 111 from which a liquid is to be discharged. The nozzles 111 are two-dimensionally arranged in a matrix.

The first substrate 190 forms multiple pressure chambers 121 (individual chambers or individual channels) communicating with the nozzles 111, respectively, and multiple common supply channel branches 152 as common channel branches each communicating with two or more pressure chambers 121. On the first substrate 190, piezoelectric elements 140 to pressurize the pressure chambers 121 are arranged.

The first substrate 190 also forms a part 156a of a common supply main channel 156 that is one or more in number and communicates with the common supply channel branches 152.

The second substrate 170 is a common main channel member and forms the common supply main channel 156 as a common channel communicating with the common supply channel branches 152. In the present embodiment, the common supply main channel 156 serving as a common channel is arranged on both sides in a transverse direction of the second substrate 170.

In the frame member 180, a supply port 181 and a supply path 183 that communicates with the supply port 181 and the common supply main channel 156 are formed.

In the liquid discharge head 100, multiple reinforcements 171 extending in a direction intersecting a longitudinal direction of the common supply main channel 156 are provided in a region of the second substrate 170 that forms the common supply main channel 156, as illustrated in FIGS. 3, 6, and 7.

In the present embodiment, the reinforcements 171 have a thickness t2 equal to a thickness t1 of the second substrate 170. Consequently, the common supply main channel 156 is divided by the reinforcements 171 into multiple (three in the illustrated example) openings (channel parts) 156A in the longitudinal direction of the common supply main channel 156.

As a result, the second substrate 170 in the form of a thin layer has a high rigidity as compared with the case where one long opening is formed as a common channel (the common supply main channel 156 in the present embodiment).

A high rigidity of the second substrate 170 reduces the damage due to the expansion (division) during the manufacture of the liquid discharge head 100.

The damper member 160 is bonded on a bonding side of the second substrate 170 to be bonded to the first substrate 190. On the bonding side of the second substrate 170 to be bonded to the first substrate 190, a recess 178 serving as a damper chamber is formed.

The damper member 160 forms deformable walls of the common supply channel branches 152. The damper member 160 doubles as a filter member, and a region corresponding to the common supply main channel 156 of the second substrate 170 is made to be a filter region 163 where many (multiple) filter holes 164 are formed, as illustrated in FIG. 4A.

Next, the expansion is explained further referring to FIG. 8. FIG. 8 is a plan view for explaining the expansion.

On a silicon wafer 914, many second substrates 170a are formed that are each used as the second substrate 170 after the division of the silicon wafer 914. A dicer or the like is used to make cracks in the silicon wafer 914, on which the second substrates 170a have been formed, as division lines 913.

Then, a dicing tape 915 that the silicon wafer 914 has been adhered to is pulled in 360-degree directions as illustrated with arrows in the figure, so as to divide the silicon wafer 914 along the division lines 913 into individual second substrates 170 each in a chip form.

During the division, the second substrate 170 may be deformed in accordance with the stretch of the dicing tape 915 if the second substrate 170 has a pattern with a low rigidity.

The reinforcements 171 provided in an opening forms the common supply main channel 156 of the second substrate 170. The reinforcements 171 suppress the deformation of the second substrate 170 during the expansion. Thus, the reinforcements 171 can prevent the damage of a chip of the second substrate 170, generation of silicon flakes by rubbing of chips, and the like.

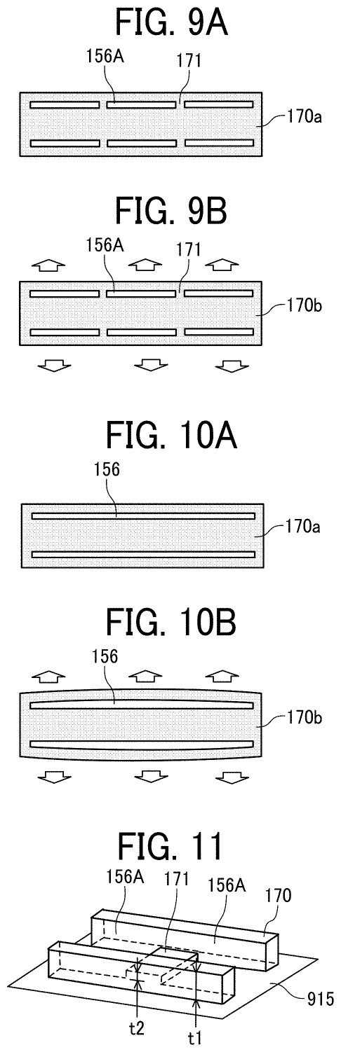

Effects of reinforcements are explained with reference to FIGS. 9A, 9B, 10A, and 10B.

FIGS. 9A and 9B are plan views of the second substrate in the first embodiment, and FIGS. 10A and 10B are plan views of a second substrate in Comparative Example 1. FIGS. 9A and 10B are each to illustrate the state of the second substrate before the expansion, and FIGS. 9B and 10B are each to illustrate the state of the second substrate after the expansion.

As also illustrated in FIGS. 9A and 9B, the second substrate 170a in the first embodiment includes the reinforcements 171 provided in the common supply main channel 156. The second substrate 170a in Comparative Example 1 forms a common supply main channel 156 that consists of one elongated opening, as illustrated in FIGS. 10A and 10B.

A wafer that the second substrates 170a in the first embodiment have been formed on and a wafer that the second substrates 170a in Comparative Example 1 have been formed on were prepared so as to check whether deformation actually occurs during the expansion, and whether the damage of a part and the generation of foreign bodies are observed. On both of the second substrates 170a in the first embodiment and the second substrates 170a in Comparative Example 1, a silicon membrane serving as the damper member 160 was formed.

In Comparative Example 1, five wafers were prepared and expanded and, as a result, the deformation of a chip of a second substrate 170b after the expansion as illustrated in FIG. 10B was observed on every chip of every wafer. The second substrate 170b with the maximum deformation exhibited deformation of about 350 μm in the transverse direction.

With respect to the damper member 160 formed on the second substrates 170a, the damage of the membrane was recognized on about 60% of the chips. When five chips were extracted to check on foreign bodies, it was found that a maximum of about 50 foreign bodies with a size of 10 μm or more were adhered to one chip.

In contrast, for the first embodiment, five wafers were prepared and expanded and, as a result, significant deformation of a chip of a second substrate 170b after the expansion was not observed on any chip of any wafer, as seen from FIG. 9B. The second substrate 170b with the maximum deformation exhibited deformation of about 10 μm in the transverse direction, namely, deformation greatly reduced from the maximum deformation in Comparative Example 1.

With respect to the damper member 160 formed on the second substrates 170a, any damage of the membrane was not recognized. When five chips were extracted to check on foreign bodies, no foreign bodies with a size of 10μm or more were recognized.

Next, a second embodiment of this disclosure is described with reference to FIG. 11. FIG. 11 is a perspective view illustrating a second substrate in a liquid discharge head according to the second embodiment, along with a dicing tape.

Also in the present embodiment, multiple reinforcements 171 extending in a direction intersecting a longitudinal direction of a common supply main channel 156 are provided in a region of a second substrate 170 that forms the common supply main channel 156.

On the other hand, in the present embodiment, the reinforcements 171 have a thickness t2 smaller than a thickness t1 of the second substrate 170 (t2<t1). In addition, the reinforcements 171 are so provided as to be closer to a bonding side of the second substrate 170 to be bonded to the first substrate 190.

Consequently, a channel extending in the longitudinal direction is maintained in the common supply main channel 156 and the volume of the common supply main channel 156 is ensured. In other words, since the reinforcements 171 with a larger volume offer a higher fluid resistance, the reinforcements 171 are reduced in volume as much as possible so as to lower the fluid resistance due to the reinforcements 171 as provided.

The reinforcements 171, which are so provided as to be closer to the bonding side of the second substrate 170 to be bonded to the first substrate 190, are in contact with the dicing tape 915 during the expansion, which is adequately effective at preventing the deformation.

With respect to the present embodiment, similarly to the first embodiment, a wafer was prepared to check the second substrate 170 during the expansion on deformation, damage, and foreign bodies. As a result, it was found that the deformation of the second substrate 170 was of an amount of at most about 10 μm, the membrane of the damper member 160 was not damaged, and no foreign bodies with a size of 10 μm or more were present.

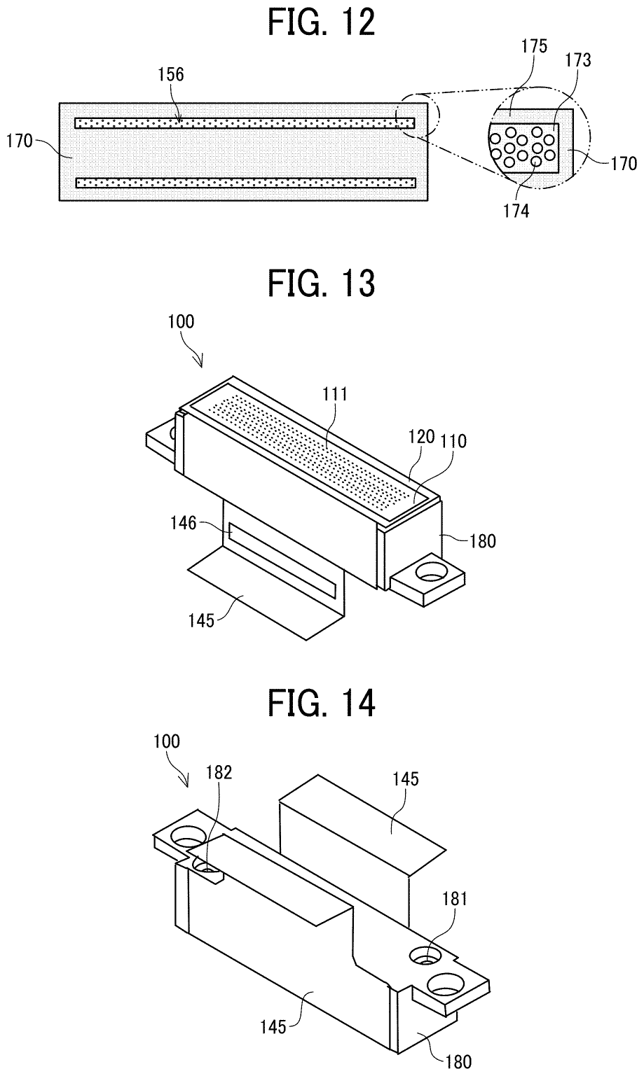

Next, a third embodiment of this disclosure is described with reference to FIG. 12. FIG. 12 is a plan view of a second substrate 170 in a liquid discharge head according to the third embodiment, with a left part illustrating the second substrate 170 as a whole and a right part illustrating part of the second substrate 170 in an enlarged manner.

In the present embodiment, many (multiple) holes 174 are provided in a hole region 173 of a second substrate 170 that forms a common main channel, so as to form a common supply main channel 156 with the holes 174. A region other than the hole region 173 of the second substrate 170 is referred to as a “non-hole region 175” (see FIG. 12).

Such configuration increases the rigidity of the second substrate 170.

The holes 174 can be made equal in opening area to the filter holes 164 in the filter region 163 of the damper member 160 in the first embodiment.

In that case, the second substrate 170 is caused to double as a filter member and the filter region 163 of the damper member 160 in the first embodiment is made to be a simple opening.

With respect to the present embodiment, similarly to the first embodiment, a wafer was prepared to check the second substrate 170 during the expansion on deformation, damage, and foreign bodies. The holes 174 were each given a hole diameter of 24 μm that is equal to the hole diameter of the filter holes 164 in the filter region 163 of the damper member 160 in the first embodiment. The filter region 163 of the damper member 160 was made to be a simple opening.

As a result, it was found that the deformation of the second substrate 170 was of a measurement error-level amount of about 1.2 μm, the membrane of the damper member 160, whose filter region 163 was a simple opening, was not damaged, and no foreign bodies with a size of 10 μm or more were present.

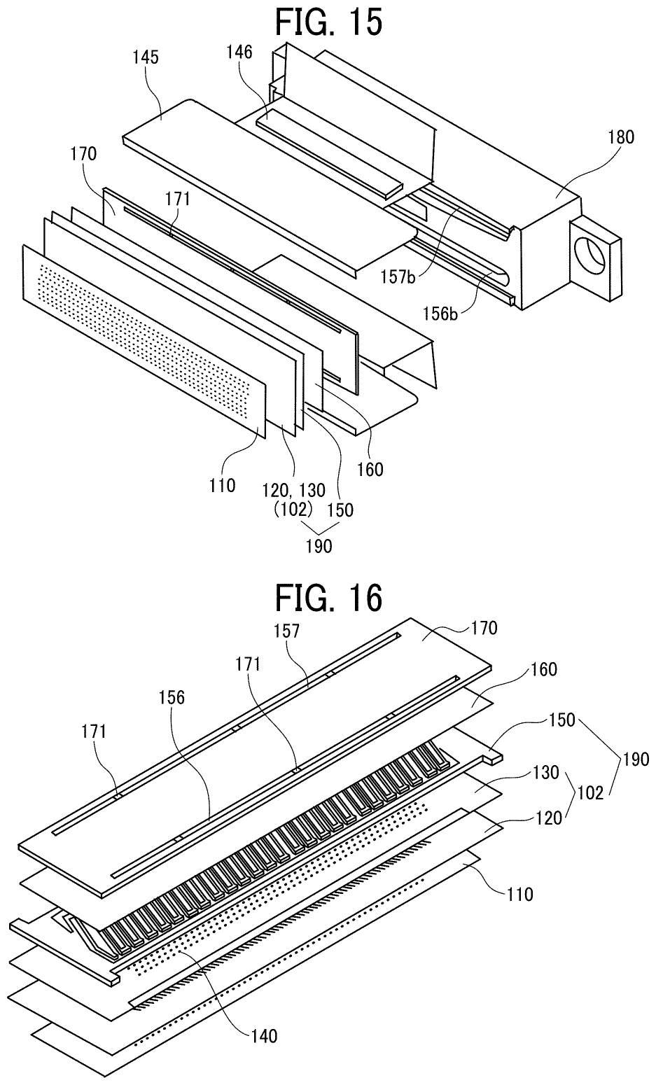

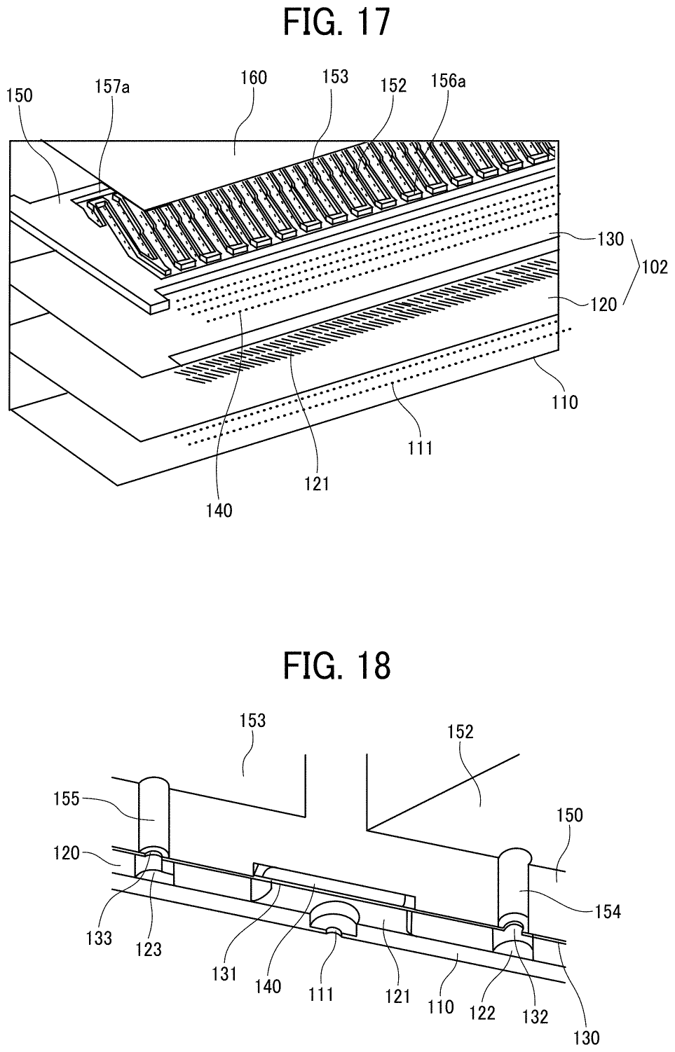

Next, a fourth embodiment of this disclosure is described with reference to FIGS. 13 through 18. FIG. 13 is a perspective view illustrating an appearance of a liquid discharge head according to the fourth embodiment as viewed from a nozzle face side, FIG. 14 is a perspective view illustrating an appearance of the liquid discharge head in FIG. 13 as viewed from a side opposite with the nozzle face side, and FIG. 15 is an exploded perspective view of the liquid discharge head in FIG. 13. FIG. 16 is an exploded perspective view of channel constituent members in the liquid discharge head in FIG. 13, FIG. 17 is an enlarged perspective view of a principal part of the channel forming components in FIG. 16, and FIG. 18 is a perspective view of a cross section of a channel part in the liquid discharge head in FIG. 13.

A liquid discharge head 100 of the present embodiment is a circulation type liquid discharge head and includes the nozzle plate 110, a channel plate (individual channel member) 120, a diaphragm member 130 including the piezoelectric elements 140, a common channel branch member 150, the damper member 160, the second substrate 170 as a common main channel member, the frame member 180, and the wiring member 145 (flexible circuit substrate). On the wiring member 145, a head driver 146 (driver integrated circuit (IC)) is mounted.

In the present embodiment, the channel plate 120 and the diaphragm member 130 form an actuator substrate 102 that the piezoelectric elements 140 are arranged on. The channel plate 120 and the common channel branch member 150 correspond to the first substrate 190 in the first embodiment.

The nozzle plate 110 has the nozzles 111 from which a liquid is to be discharged. The nozzles 11 1 are two-dimensionally arranged in a matrix.

The channel plate 120 forms the pressure chambers 121 (individual chambers) communicating with the nozzles 111, respectively, multiple individual supply channels 122 communicating with the pressure chambers 121, respectively, and multiple individual collection channels 123 communicating with the pressure chambers 121, respectively.

The diaphragm member 130 forms diaphragms 131 as deformable walls of the pressure chambers 121, and the piezoelectric elements 140 are integrally provided on the diaphragms 131. In the diaphragm member 130, supply-side openings 132 communicating with the individual supply channels 122 and collection-side openings 133 communicating with the individual collection channels 123 are formed. The piezoelectric elements 140 are pressure generating means (pressure generating elements) for deforming the diaphragms 131 so as to pressurize liquid in the pressure chambers 121.

The common channel branch member 150 forms multiple common supply channel branches 152 each communicating with two or more individual supply channels 122 and multiple common collection channel branches 153 each communicating with two or more individual collection channels 123 so that the common supply channel branches 152 and the common collection channel branches 153 may alternately be arranged.

In the common channel branch member 150, through holes serving as supply ports 154 leading from the supply-side openings 132 of the individual supply channels 122 to the common supply channel branches 152 and through holes serving as collection ports 155 leading from the collection-side openings 133 of the individual collection channels 123 to the common collection channel branches 153 are formed.

In addition, the common channel branch member 150 forms a part 156a of a common supply main channel 156 that is one or more in number and communicates with the common supply channel branches 152, and a part 157a of a common collection main channel 157 that is one or more in number and communicates with the common collection channel branches 153.

The damper member 160 includes supply-side dampers facing (opposite to) the supply ports 154 of the common supply channel branches 152 and collection-side dampers facing (opposite to) the collection ports 155 of the common collection channel branches 153. The filter region 163 described in the first embodiment can be provided on the damper member 160 as above.

With respect to the common supply channel branches 152 and the common collection channel branches 153, grooves alternately arranged on the same common channel branch member 150 are sealed with the damper member 160, which forms deformable walls, so as to form the common supply channel branches 152 and the common collection channel branches 153.

The second substrate 170 is a common main channel member, and forms the common supply main channel 156 as a common channel communicating with the common supply channel branches 152 and the common collection main channel 157 as a common channel communicating with the common collection channel branches 153.

On the frame member 180, a part 156b of the common supply main channel 156 and a part 157b of the common collection main channel 157 are formed.

The part 156b of the common supply main channel 156 communicates with the supply port 181 provided on the frame member 180, and the part 157b of the common collection main channel 157 communicates with a collection port 182 provided on the frame member 180.

In the liquid discharge head 100 of the present embodiment, driving pulses are applied to the piezoelectric elements 140 so as to subject the piezoelectric elements 140 to flexural deformation, and the liquid in the pressure chambers 121 as pressurized by the deformed piezoelectric elements 140 is discharged dropwise through the nozzles 111.

If the discharge of liquid from the liquid discharge head 100 is not performed or liquid has not been discharged through the nozzles 111, the liquid circulates via a circulation path that the collection port 182 and the supply port 181 are connected to.

Also in the present embodiment, the second substrate 170 includes reinforcements 171 provided in parts forming the common supply main channel 156 and the common collection main channel 157. The reinforcements 171 can have either of the thickness in the first embodiment and the thickness in the second embodiment. The common supply main channel 156 and the common collection main channel 157 may have the configuration of the common supply main channel 156 in the third embodiment.

In that case, the rigidity of the second substrate 170 is also increased in the present embodiment.

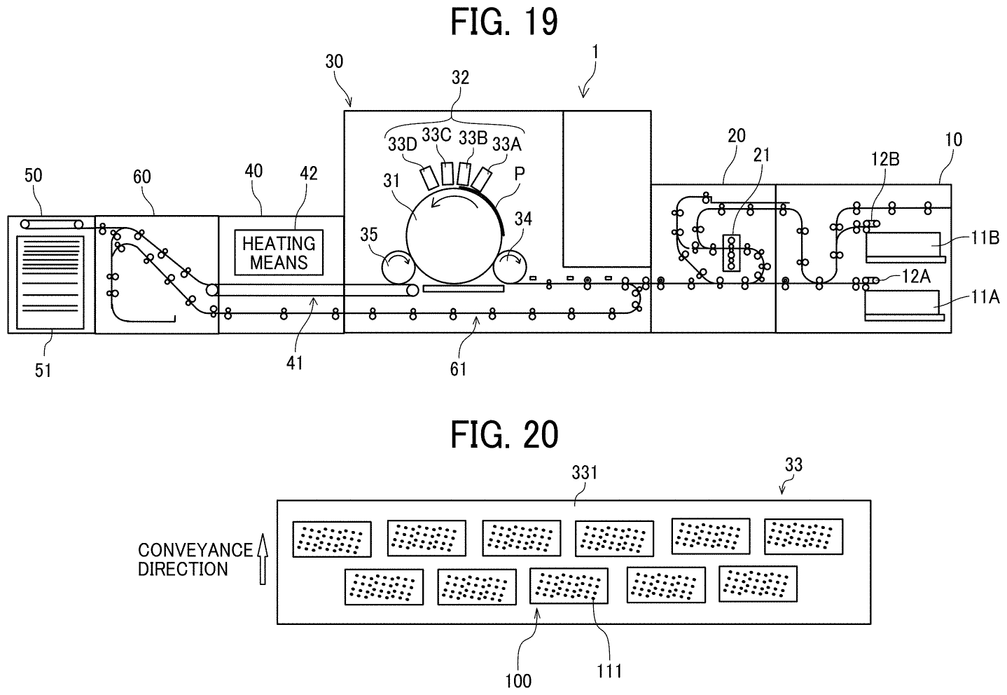

Next, an example of a printing apparatus as a liquid discharging apparatus according to this disclosure is described with reference to FIGS. 19 and 20. FIG. 19 is a schematic side view of an exemplary printing apparatus, and FIG. 20 is a plan view of a discharge unit of the printing apparatus in FIG. 19.

A printing apparatus 1 is a liquid discharging apparatus and includes a sending-in section 10 for sending in a cut sheet P, a pretreatment section 20, a printing section 30, a drying section 40, a reversion mechanism section 60, and a sending-out section 50.

In the printing apparatus 1, the pretreatment section 20 as a pretreatment means gives (applies), as desired, a pretreatment liquid to the cut sheet P sent in (fed) from the sending-in section 10, the printing section 30 gives liquid to the cut sheet P so as to perform a desired printing, and the drying section 40 dries the liquid adhered to the cut sheet P and then ejects the cut sheet P to the sending-out section 50.

The sending-in section 10 includes sending-in trays 11 (a lower sending-in tray 11A and an upper sending-in tray 11B) each containing multiple cut sheets P and feeding devices 12 (12A and 12B) for delivering the cut sheets P one by one from the sending-in trays 11, and is to feed the cut sheets P to the pretreatment section 20.

The pretreatment section 20 includes an applicator 21 as a treatment liquid giving means that gives a printing face of the cut sheet P a treatment liquid having an effect of condensing ink so as to prevent offset, for instance.

The printing section 30 includes a drum 31 as a carrying member (rotating member) that carries the cut sheet P on a peripheral face and as such rotates, and a liquid discharger 32 for discharging liquid toward the cut sheet P carried by the drum 31.

The printing section 30 also includes a transfer barrel 34 that receives the cut sheet P sent from the pretreatment section 20, so as to transfer the cut sheet P to the drum 31, and a transfer barrel 35 that receives the cut sheet P conveyed by the drum 31, so as to transfer the cut sheet P to the drying section 40.

The cut sheet P conveyed from the pretreatment section 20 to the printing section 30 is grasped by a leading edge by a grasping means (sheet gripper) provided on the transfer barrel 34, and conveyed in accordance with the rotation of the transfer barrel 34. The cut sheet P conveyed by the transfer barrel 34 is transferred to the drum 31 in a position opposite to the drum 31.

On a surface of the drum 31, another grasping means (sheet gripper) is provided that is to grasp the cut sheet P by the leading edge. Multiple suction holes are so formed in the surface of the drum 31 as to be distributed, and a suction means is used to generate a suction air flow directed from a desired suction hole of the drum 31 inward.

The cut sheet P transferred from the transfer barrel 34 to the drum 31 is grasped by the leading edge by the sheet gripper and, at the same time, attracted onto and carried on the drum 31 by means of the suction air flow generated by the suction means, and as such 5 conveyed in accordance with the rotation of the drum 31.

The liquid discharger 32 includes discharge units 33 (33A through 33D) as liquid discharging means. For instance, a discharge unit 33A discharges a cyan (C) liquid, a discharge unit 33B discharges a magenta (M) liquid, a discharge unit 33C discharges a yellow (Y) liquid, and a discharge unit 33D discharges a black (K) liquid. Another discharge unit for discharging a special liquid, such as a white liquid and a gold (silver) liquid, may also be used.

The discharge units 33 are each a full-line head where multiple liquid discharge heads 100 according to this disclosure, each including the nozzles 111 as two-dimensionally arrayed in a matrix, are staggered on a base 331 as illustrated in FIG. 20, for instance.

The discharge units 33 of the liquid discharger 32 are each controlled with respect to a discharging operation, based on a driving signal according to printing information. When the cut sheet P carried by the drum 31 passes through a region opposite to the liquid discharger 32, liquids of different colors are discharged from the discharge units 33 so as to print an image according to the printing information.

The cut sheet P, which has been given the liquids by the liquid discharger 32, is transferred from the drum 31 to the transfer barrel 35 and then transferred by the transfer barrel 35 to a conveyance mechanism 41 that sends the cut sheet P to the drying section 40.

In the drying section 40, the cut sheet P conveyed by the conveyance mechanism 41 is heated by a heating means 42 so as to dry the liquids adhered to the cut sheet P. As a result, liquid ingredients such as water in the liquids evaporate, colorants contained in the liquids are fixed onto the cut sheet P, and the curl of the cut sheet P is suppressed.

The reversion mechanism section 60 includes a mechanism for reversing the cut sheet P on a switchback basis if duplex printing is to be performed on the cut sheet P having passed through the drying section 40. The cut sheet P as reversed is sent back upstream from the transfer barrel 34 via a two-way conveyance path 61.

The sending-out section 50 includes a sending-out tray 51 where multiple cut sheets P are loaded. The cut sheets P conveyed from the drying section 40 via the reversion mechanism section 60 are sequentially stacked on the sending-out tray 51 and as such held.

In the present embodiment, discharged liquid is not limited to a particular liquid as long as the liquid has a viscosity or surface tension to be discharged from a head (liquid discharge head).

However, preferably, the viscosity of the liquid is not greater than 30 mPas under ordinary temperature and ordinary pressure or by heating or cooling. More specifically, examples thereof include solutions, suspensions, and emulsions containing solvents such as water and organic solvents, colorants such as dyes and pigments, function-imparting materials such as polymerizable compounds, resins, and surfactants, biocompatible materials such as DNA, amino acids, proteins, and calcium, edible materials such as natural pigments, and the like.

Examples of an energy source to generate energy to discharge liquid include a piezoelectric actuator (a laminated piezoelectric element or a thin-film piezoelectric element), a thermal actuator that employs a thermoelectric conversion element, such as a heating resistor, and an electrostatic actuator including a diaphragm and opposed electrodes.

The “liquid discharge device” is an assembly of parts relating to liquid discharge. The term “liquid discharge device” represents a structure including the head and a functional part(s) or unit(s) combined to the head to form a single unit. For example, the “liquid discharge device” includes a combination of the head with at least one of a head tank, a carriage, a supply unit, a maintenance unit, a main scan moving unit, and a liquid circulation apparatus.

Here, examples of the “single unit” include a combination in which the head and a functional part(s) or unit(s) are secured to each other through, e.g., fastening, bonding, or engaging, and a combination in which one of the head and a functional part(s) or unit(s) is movably held by another. Further, the head, the functional parts, and the mechanism may be configured to be detachable from each other.

For example, the head and the head tank may form the liquid discharge device as a single unit. Alternatively, the head and the head tank coupled (connected) with a tube or the like may form the liquid discharge device as a single unit. A unit including a filter may be added at a position between the head tank 441 and the head 404 of the liquid discharge device.

In another example, the head and the carriage may form the liquid discharge device as a single unit.

In still another example, the liquid discharge device includes the head movably held by a guide that forms part of a main scan moving unit, so that the head and the main scan moving unit form a single unit. The liquid discharge device may include the head, the carriage, and the main scan moving unit that form a single unit.

In still another example, a cap that forms a part of the maintenance unit may be secured to the carriage mounting the head so that the head, the carriage, and the maintenance unit form a single unit to form the liquid discharge device.

Further, in still another example, the liquid discharge device includes tubes connected to the head tank or the head mounting a channel member so that the head and the supply unit form a single unit.

A liquid in a liquid reservoir source such as an ink cartridge is supplied to the head through this tube.

The main scan moving unit may be a guide only.

The supply unit may be a tube(s) only or a loading unit only.

The “liquid discharge device” includes a head module including the above-described head, and a head device in which the above-described functional components and mechanisms are combined to form a single unit.

The term “liquid discharge apparatus” used herein also represents an apparatus including the head, the liquid discharge device, the head module, the head device, and the liquid discharge device to discharge liquid by driving the head.

The liquid discharge apparatus may be, for example, an apparatus capable of discharging a liquid to a material to which liquid can adhere or an apparatus to discharge liquid toward gas or into liquid.

The “liquid discharge apparatus” may include devices to feed, convey, and eject the material on which liquid can adhere. The liquid discharge apparatus may further include a pretreatment apparatus to coat a treatment liquid onto the material, and a post-treatment apparatus to coat a treatment liquid onto the material, onto which the liquid has been discharged.

The “liquid discharge apparatus” may be, for example, an image forming apparatus to form an image on a sheet by discharging ink, or a three-dimensional fabrication apparatus to discharge a fabrication liquid to a powder layer in which powder material is formed in layers to form a three-dimensional fabrication object.

The “liquid discharge apparatus” is not limited to an apparatus to discharge liquid to visualize meaningful images, such as letters or figures. For example, the liquid discharge apparatus may be an apparatus to form arbitrary images, such as arbitrary patterns, or fabricate three-dimensional images.

The above-described term “material on which liquid can be adhered” represents a material on which liquid is at least temporarily adhered, a material on which liquid is adhered and fixed, or a material into which liquid is adhered to permeate. Examples of the “material on which liquid can be adhered” include recording media, such as paper sheet, recording paper, recording sheet of paper, film, and cloth, electronic component, such as electronic substrate and piezoelectric element, and media, such as powder layer, organ model, and testing cell. The “material on which liquid can be adhered” includes any material on which liquid is adhered, unless particularly limited.

The above-mentioned “material onto which liquid can be adhered” may be any material as long as liquid can temporarily adhere such as paper, thread, fiber, cloth, leather, metal, plastic, glass, wood, ceramics, or the like.

The “liquid discharge apparatus” may be an apparatus to relatively move the head and a material on which liquid can be adhered. However, the liquid discharge apparatus is not limited to such an apparatus. For example, the liquid discharge apparatus may be a serial head apparatus that moves the head or a line head apparatus that does not move the head.

Examples of the “liquid discharge apparatus” further include a treatment liquid coating apparatus to discharge a treatment liquid to a sheet to coat, with the treatment liquid, a sheet surface to reform the sheet surface and an injection granulation apparatus in which a composition liquid including raw materials dispersed in a solution is discharged through nozzles to granulate fine particles of the raw materials.

The terms “image formation”, “recording”, “printing”, “image printing”, and “fabricating” used herein may be used synonymously with each other.

According to this embodiment, the rigidity of the common flow path member can be increased.

[Aspect 1]

A liquid discharge head (100) includes: a nozzle plate (110) having multiple nozzles (111) from each of which a liquid is to be discharged; a first substrate (190) including multiple pressure chambers (121) respectively communicating with the multiple nozzles (111); and a second substrate (170) including: a common channel (156) communicating with the multiple pressure chambers (121), the common channel (156) extending in a longitudinal direction of the second substrate (170); and a reinforcement (171) in the common channel (156), the reinforcement (171) intersecting the longitudinal direction.

[Aspect 2]

In the liquid discharge head (100) according to Aspect 1, the reinforcement (171) has a thickness smaller than a thickness of the second substrate (170).

[Aspect 3]

In the liquid discharge head (100) according to Aspect 2, the reinforcement (171) is closer to one side in a thickness direction of the second substrate (170).

[Aspect 4]

In the liquid discharge head (100) according to Aspect 3, the first substrate (190) and the second substrate (170) are bonded with each other at a bonding surface, and the reinforcement (171) of the second substrate (170) is closer to the bonding surface in the thickness direction.

[Aspect 5]

A liquid discharge head (100) includes: a nozzle plate (110) having multiple nozzles (111) from each of which a liquid is to be discharged; a first substrate (190) including multiple pressure chambers (121) respectively communicating with the multiple nozzles (111); and a second substrate (170) including a hole region (173) having multiple holes (174), the multiple holes (174) defining a common channel (156) communicating with each of the multiple pressure chambers (121).

[Aspect 6]

In the liquid discharge head (100) according to Aspect 5, wherein the hole region (173) has a thickness smaller than a thickness of a non-hole region (175) other than the hole region (173) of the second substrate (170).

[Aspect 7]

In the liquid discharge head according to Aspect 6, the hole region (173) is closer to one side in a thickness direction of the second substrate (170).

[Aspect 8]

In the liquid discharge head according to Aspect 7, the first substrate (190) and the second substrate (170) are bonded with each other at a bonding surface, and the hole region (173) of the second substrate (170) is closer to the bonding surface in the thickness direction.

[Aspect 9]

In the liquid discharge head according to Aspect 8, the multiple holes (174) of the hole region (173) is a filter configured to filtering the liquid passing through the multiple holes (174) from the common channel (156) of the second substrate (170) to the multiple pressure chambers (121) of the first substrate (190).

[Aspect 10]

In a discharge unit (33) includes the liquid discharge head according to Aspect 1, the liquid discharge head (100) includes multiple liquid discharge heads (100).

[Aspect 11]

A liquid discharging apparatus (1) comprising the liquid discharge head (100) according to Aspect 1.

[Aspect 12]

A liquid discharging apparatus (1) comprising the discharge unit (33) according to Aspect 10.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge head comprising:
a nozzle plate having multiple nozzles from each of which a liquid is to be discharged;
a first substrate including multiple pressure chambers respectively communicating with the multiple nozzles; and
a second substrate including:
a common channel communicating with the multiple pressure chambers, the common channel extending in a longitudinal direction of the second substrate; and
a reinforcement in the common channel, the reinforcement intersecting the longitudinal direction.

2. The liquid discharge head according to claim 1,
wherein the reinforcement has a thickness smaller than a thickness of the second substrate.

3. The liquid discharge head according to claim 2,
wherein the reinforcement is closer to one side in a thickness direction of the second substrate.

4. The liquid discharge head according to claim 3,
wherein the first substrate and the second substrate are bonded with each other at a bonding surface, and
the reinforcement of the second substrate is closer to the bonding surface in the thickness direction.

5. A liquid discharge head comprising:
a nozzle plate having multiple nozzles from each of which a liquid is to be discharged;
a first substrate including multiple pressure chambers respectively communicating with the multiple nozzles; and
a second substrate including a hole region having multiple holes, the multiple holes defining a common channel communicating with each of the multiple pressure chambers.

6. The liquid discharge head according to claim 5, wherein the hole region has a thickness smaller than a thickness of a non-hole region other than the hole region of the second substrate.

7. The liquid discharge head according to claim 6,
wherein the hole region is closer to one side in a thickness direction of the second substrate.

8. The liquid discharge head according to claim 7,
wherein the first substrate and the second substrate are bonded with each other at a bonding surface, and
the hole region of the second substrate is closer to the bonding surface in the thickness direction.

9. The liquid discharge head according to claim 5,
wherein the multiple holes of the hole region is a filter configured to filtering the liquid passing through the multiple holes from the common channel of the second substrate to the multiple pressure chambers of the first substrate.

10. A discharge unit comprising the liquid discharge head according to claim 1,
wherein the liquid discharge head includes multiple liquid discharge heads.

11. A liquid discharging apparatus comprising the liquid discharge head according to claim 1.

12. A liquid discharging apparatus comprising the discharge unit according to claim 10.
